(19) United States
(12) Patent Application Publication
(10) Pub. No.: US 2011/0088732 A1
(43) Pub. Date: Apr. 21, 2011

(54) FLEXIBLE TANK CLEANING APPARATUS WITH CONTROL LINKAGE

(76) Inventor: Donald D. Savard, Edmonton (CA)

(21) Appl. No.: 12/999,229

(22) PCT Filed: Jul. 2, 2009
(86) PCT No.: PCT/CA09/00909

§ 371 Date: Dec. 15, 2010

(30) Foreign Application Priority Data
Jul. 2, 2008 (CA) 2637286

(51) Int. Cl. B08B 9/00

(52) U.S. Cl. 134/166 R

(57) ABSTRACT

An apparatus for cleaning a tank that is to be installed below the fill line of a tank includes a housing sealably attached to a sidewall of a tank, and a tubing having a flexible output end positioned within the housing such that the output end of the tubing extends past the sidewall of the tank. A control linkage is slidably positioned within the housing. The control linkage is connected to the flexible output end of the tubing. The control linkage is movable between an extended position and a retracted position. The orientation of the flexible output end of the tubing is changed as the control linkage is moved between positions, such that the direction of fluid flowing out of the flexible output end of the tubing is also changed. A seal is provided for sealing the tubing and the control linkage within the housing.

### FIELD

An apparatus for cleaning the inside of a tank.

### BACKGROUND

In many storage tanks used in various fields, sediment often collects on the bottom of the tank. To ensure that tank volumes are not lost to this sediment accumulation, or if the tank needs to be cleaned for other reasons such as required inspections, change or storage service, the sediment must be removed. It can be removed manually or by remote re-suspension, which often involves fluid pressure directed into the tank.

### SUMMARY

There is provided an apparatus for cleaning a tank that is to be installed below the fill line of a tank. The apparatus comprises a housing sealably attached to a sidewall of a tank, and a tubing having a flexible output end positioned within the housing such that the output end of the tubing extends past the sidewall of the tank. A control linkage is slidably positioned within the housing. The control linkage is connected to the flexible output end of the tubing and extending outside the tank. The control linkage is movable between an extended position and a retracted position. The orientation of the flexible output end of the tubing is changed as the control linkage is moved between positions, such that the direction of fluid flowing out of the flexible output end of the tubing is also changed. A seal is provided for sealing the tubing and the control linkage within the housing. The seal permits sliding movement of the control linkage through the seal.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top plan sectional view of an apparatus for cleaning a tank.

FIG. 2 is a perspective view of the apparatus of FIG. 1.

FIG. 3 is a top plan sectional view of the apparatus of FIG. 1 oriented to a first side.

FIG. 4 is a top plan sectional view of the apparatus of FIG. 1 oriented to a second side.

FIG. 5 is a top plan sectional view of the apparatus of FIG. 1 installed in the flange of a tank.

FIG. 6 is a perspective view of the apparatus of FIG. 1 installed on a tank.

### DETAILED DESCRIPTION

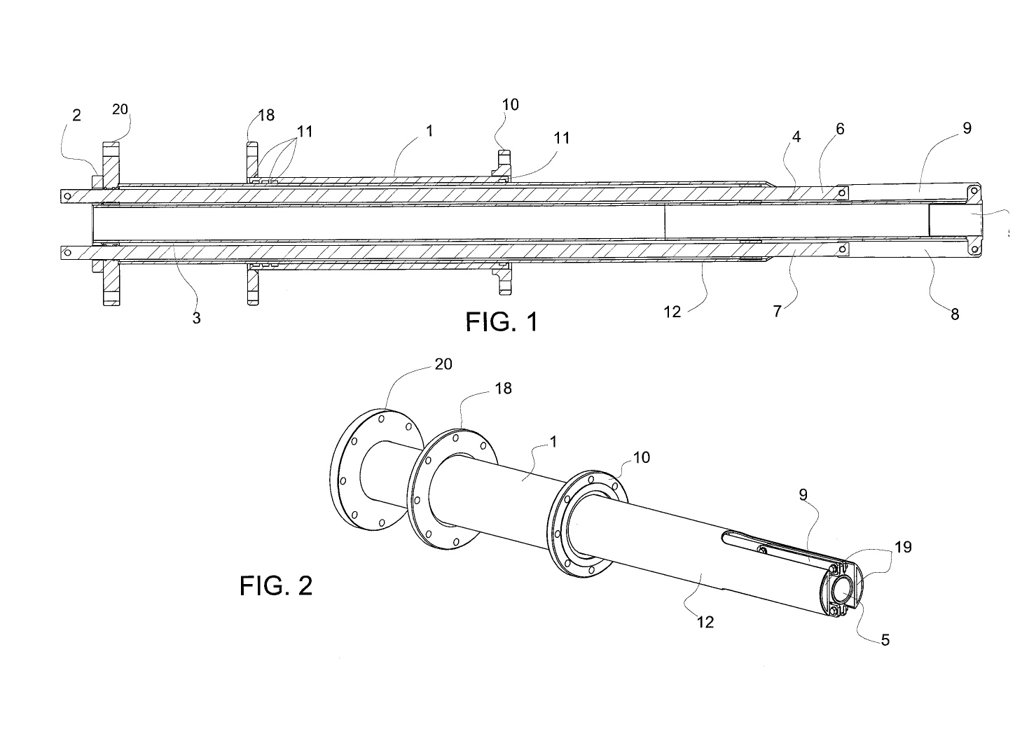

An apparatus for cleaning a tank, generally identified by reference numeral 100, will now be described with reference to FIG. 1 through 6.

### Structure and Relationship of Parts:

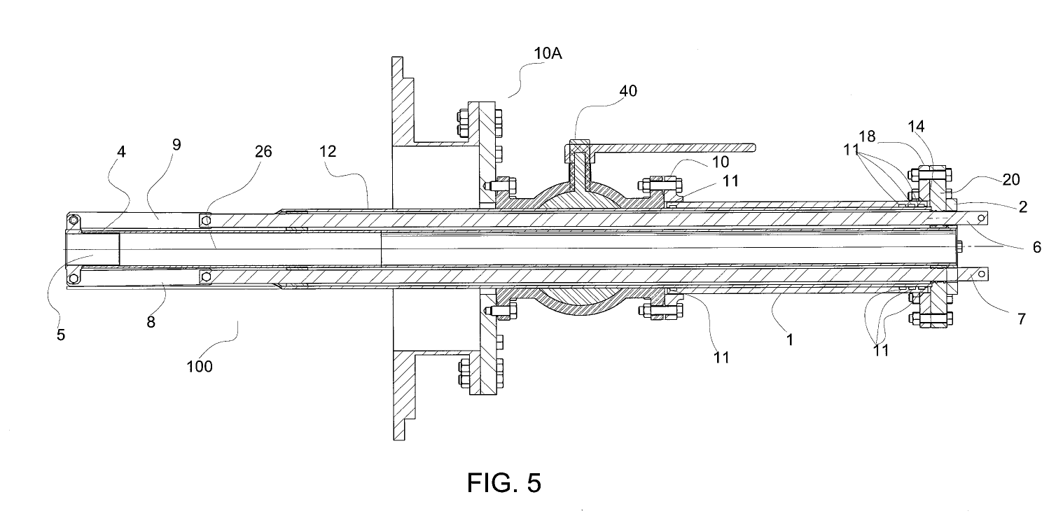

Referring to FIG. 1, apparatus 100 can be used as a permanent device installed on the tank, or as a temporary unit for tank cleaning. Referring to FIG. 5, apparatus 100 can be installed through a small opening in the tank using a stuffing box 1 so that the tank does not have to be taken out of service, or once the tank is out of service, the apparatus can be installed in an existing opening.

Referring to FIG. 1, apparatus 100 consists of a flow inlet flange 2 where fluid is pumped into the tank. Tubing with a flexible output end, such as a flow pipe 3 with a hose 4 attached to the end of flow pipe 3, is welded or otherwise attached and sealed to inlet flange 2. Fluid flows through the interior 26 of flowpipe 3, and exits into the interior of a tank through a nozzle 5. Flow pipe 3 is positioned within a housing pipe 12 that is sealed to the tank by a stuffing box 1. Control linkages made up of control rods 6 and 7 and connector rods 8 and 9, are used to control the position and orientation of nozzle 5, and thus control the direction of fluid flow into the tank. Control linkages must also be sealed within a housing pipe 12. As shown, this is done by extending rods 6 and 7 through a flange 20, and providing O-ring seals 21 about the rods 6 and 7. In addition, while two control linkages are provided, it will be understood that apparatus 100 may also operate with a single linkage. However it has been found that more favourable results may be obtained by using two.

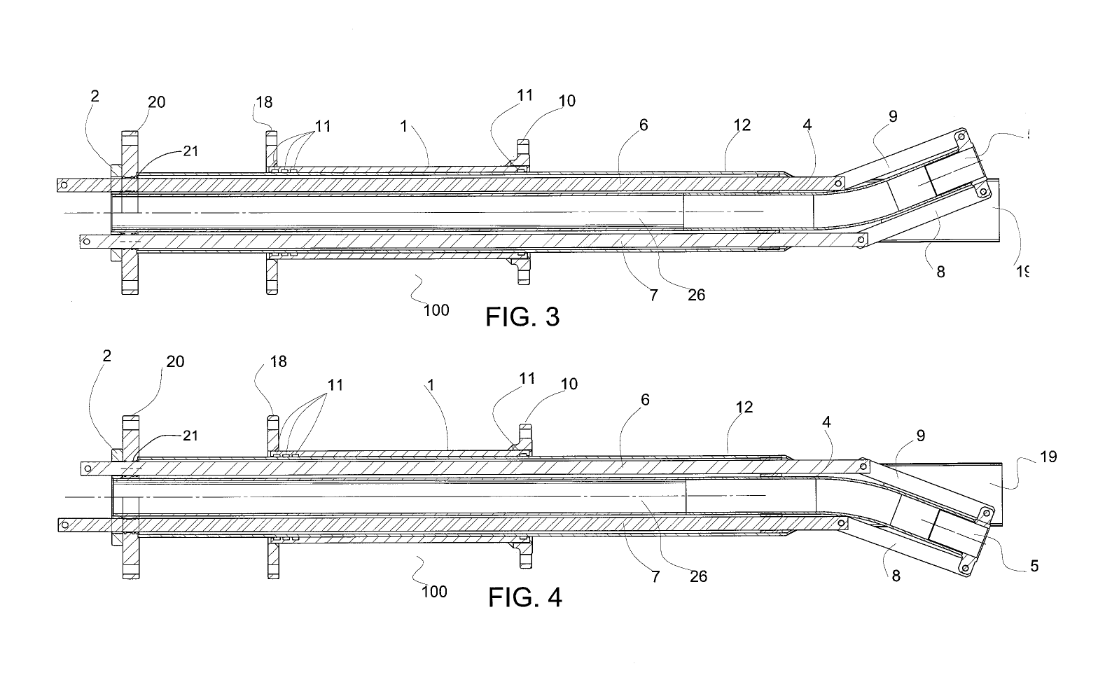

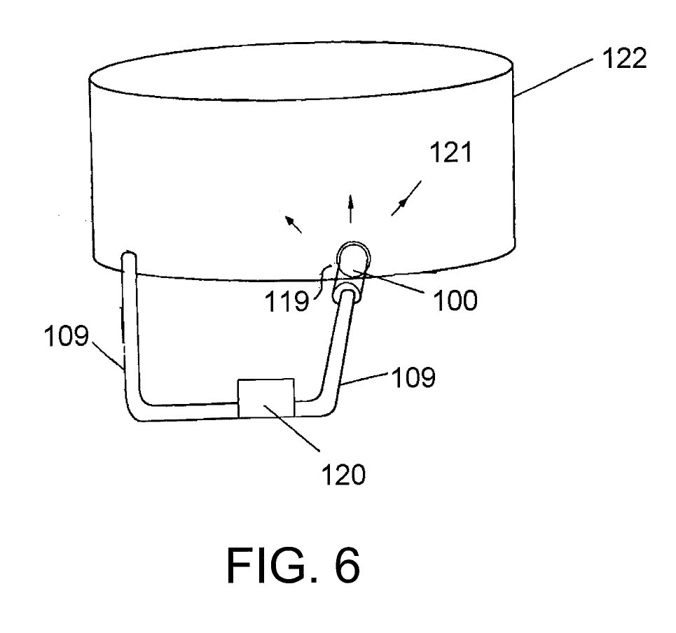

Referring to FIG. 2, guide bars 19 are used to guide the nozzle in and out of pipe 3 as it rotates through the various orientations. Referring to FIGS. 3 and 4, by pushing or pulling control rods 6 or 7 which are connected to connector rods 8 and 9 on each side of the nozzle 5 between an extended and a retracted position, the orientation of the nozzle 5 can be moved in an arc. The pipe assemblies 3, hose 4 and nozzle 5 are constructed to ensure that fluid is discharged with minimal disruption to flow. Referring to FIG. 5, the stuffing box 1 is attached to the tank by bolting flange 10 to the tank flange 10A or valve 40. Seals 11 between apparatus stuffing box 1 and housing pipe 12 are used to keep fluid from leaking from the tank. The pipe 12 is fixed to allow nozzle 5 to move horizontally allowing the flow from nozzle 5 to reach all areas of the tanks bottom. Other orientations may also be used, depending on the preferences of the user. Flange 18 and 20 are used to keep the apparatus from being forced into or out of the tank. An expandable plug (not shown) is installed in the flow pipe 3 when the system is not in use and is removed using a special tool that prevents the escape of fluid when the apparatus system is to be used. When not in use, a cover (not shown) can be placed over the complete system to ensure that the tank is fully secured. Referring to FIG. 6, the complete re-suspension is shown. Piping 109 is connected to tank 122 and pump 120. Piping 109 is hooked to apparatus 100 at flange 119 on tank 122. Fluid is then pumped through apparatus 100 and directed to all quadrants 121 of the tank ensuring that all areas of the tank are cleaned.

### Advantages:

The apparatus will be especially useful where there is limited access to the interior of the tank. The use of controlled high velocity fluid is a proven technology to re-suspend the sediment that has settled. The design of the apparatus ensures that re-suspension fluid velocity is controlled and not compromised during the operation of the unit. The apparatus is designed so that unimpeded fluid flows are available when required, but also to allow fluid to reach all section of a tank's bottom with sufficient flow to re-suspend material adhered to these surfaces. The unit is especially efficient when used in crude oil storage tanks where sediment from the production of crude oil is deposited in the bottom of the storage tanks used for crude oil production. The design of the unit allows for the installation in a very small opening, although the apparatus can also be installed in large openings if required. The unit can be removable, or may remain permanently installed on the tank to facilitate cleaning at a later date or on those tanks that need regular cleaning.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. An apparatus for cleaning a tank to be installed below the fill line of a tank, comprising:
a housing sealably attached to a sidewall of a tank;
a tubing having a flexible output end positioned within the housing such that the output end of the tubing extends past the sidewall of the tank;
a control linkage slidably positioned within the housing, the control linkage being connected to the flexible output end of the tubing and extending outside the tank, the control linkage being movable between an extended position and a retracted position, the orientation of the flexible output end of the tubing being changed as the control linkage is moved between positions such that the direction of fluid flowing out of the flexible output end of the tubing is also changed; and
a seal for sealing the tubing and the control linkage within the housing, the seal permitting sliding movement of the control linkage through the seal.

2. The apparatus of claim 1, further comprising a stuffing box for sealably attaching the housing to the sidewall of the tank.

3. The apparatus of claim 1, wherein the tubing comprises a rigid portion adjacent to the flexible output end and extending outward from the housing.

4. The apparatus of claim 1, comprising a first and a second control linkage for changing the orientation of the flexible output end of the tubing.

5. The apparatus of claim 1, wherein the control linkage comprises a control rod connected to a connector rod by a hinge, the control rod being slidably engaged by the seal, the connector rod pivoting about the hinge as the control linkage is moved between the extended position and the retracted position

6. The apparatus of claim 1, wherein the tubing is fed cleaning fluid via a pump.

7. The apparatus of claim 6, wherein the cleaning fluid is fluid from the tank.

8. The apparatus of claim 1, further comprising a plug for plugging the tubing when the tubing is removed.

9. The apparatus of claim 1, wherein the tubing comprises a valve, the valve being closed to prevent fluid within the tank from escaping through the tubing.
